(19) United States
(12) Patent Application Publication
(10) Pub. No.: US 2015/0251407 A1
(43) Pub. Date: Sep. 10, 2015

(54) PAINTING MASK WITH SPECIALIZED INDICIA

(71) Applicant: Heath Moore, Savannah, GA (US)

(72) Inventor: Heath Moore, Savannah, GA (US)

(21) Appl. No.: 14/198,295

(22) Filed: Mar. 5, 2014

(51) Int. Cl. B41F 15/34

(52) U.S. Cl. CPC B41F 15/34

(57) ABSTRACT

A stencil panel used when multiple paint layers are applied to a surface has indicia that (1) indicate the final paint color to be applied to the surface, and (2) are visible to a user even if covered by layers of paint. The indicia may be raised or comprised of a material that can be seen through the paint layer(s).

### FIELD OF THE INVENTION

The present invention relates to masks or stencils used in painting wherein the indicia remain visible even if covered with paint.

### BACKGROUND OF THE INVENTION

It is known to use stencils or masks when painting surfaces. Sometimes the stencils or masks (collectively from here forward, “stencils” or “stencil panels”) include indicia, such as numbers, colors or shapes explaining where the stencils are to be located on the surface, located relative to other stencils and/or what color paint will be applied to each opening in the stencil. Indicia may also be used to locate one stencil panel relative one or more other stencil panels to show the position at which the panels overlap. A problem arises when a stencil has more than one (and sometimes many) coats of paint applied to it because the surface to be painted will have multiple colors. In that case, the first coat of paint, or multiple coats of paint may cover the indicia, as shown in FIGS. 1-3. If the indicia designates the color of paint ultimately to be applied to certain openings in the stencil, covering the indicia makes it time consuming for an operator to review the painting plans or diagram (especially when a large surface is being painted with multiple colors) to determine which paint color goes onto the surface under each opening.

Current stencil panels may be printed with solvent or UV curable inks and then have the shapes (or forms) through which paint is applied cut into them. Or, the stencil panel has the shapes (or forms) cut into it and no printing is applied.

These current methods of paint-masking require searching for the shapes after the first coat of paint has been applied. Sometimes painters will pre-mark each color shape with tape, but this is time consuming and impractical.

This application incorporates by reference U.S. application Ser. No. 13/605,902 filed on Sep. 6, 2012 entitled “STENCILING DEVICE AND METHOD” and invented by Heath Moore.

### SUMMARY OF THE INVENTION

A stencil panel used when multiple paint layers are applied to a surface has indicia that (1) indicate the final paint color to be applied to the surface, and (2) are visible to a user even if covered by layers of paint. The indicia may be raised or comprised of a material that can be seen through the paint layer(s).

### BRIEF DESCRIPTION OF THE DRAWINGS

FIG. 1 shows a stencil panel of the prior art.

FIG. 2 shows the stencil panel of FIG. 1 with one or more coats of paint applied to it.

FIG. 3 shows a side view of the stencil panel of FIG. 1.

FIG. 4 shows a stencil panel according to an embodiment of the invention.

FIG. 4A shows a close-up view of a portion of the stencil panel of FIG. 4.

FIG. 5 shows the stencil panel of FIG. 4 with one or more coats of paint on it.

FIG. 5A shows a close-up view of part of the stencil panel of FIG. 5.

FIG. 6 shows a side view of the stencil panel of FIG. 4.

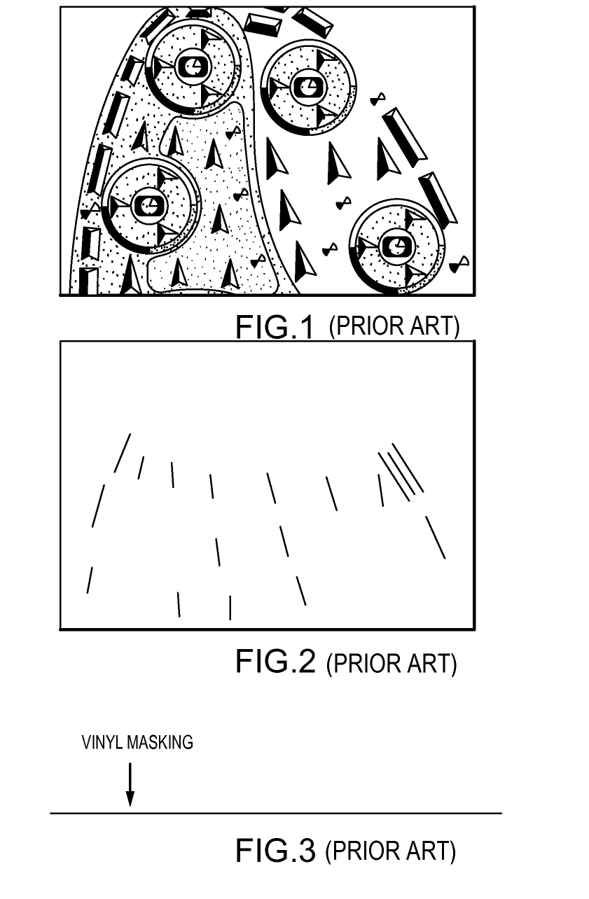

### DETAILED DESCRIPTION OF PREFERRED EMBODIMENTS

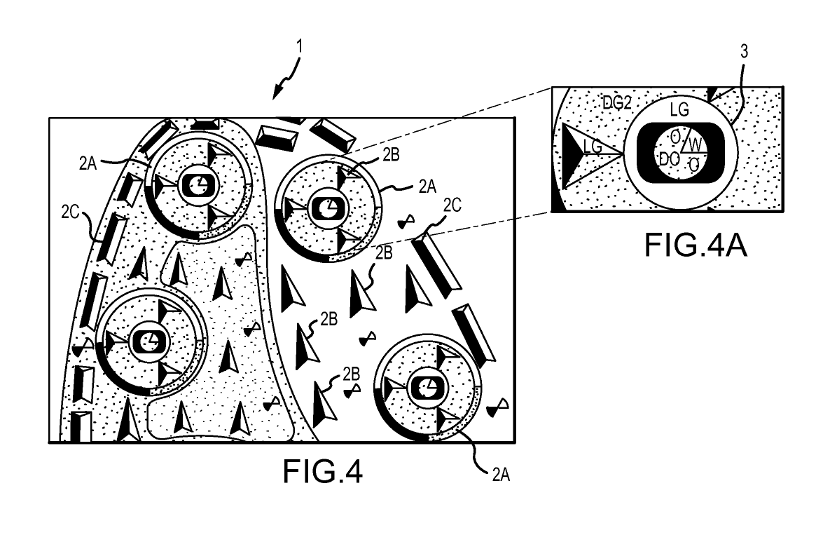

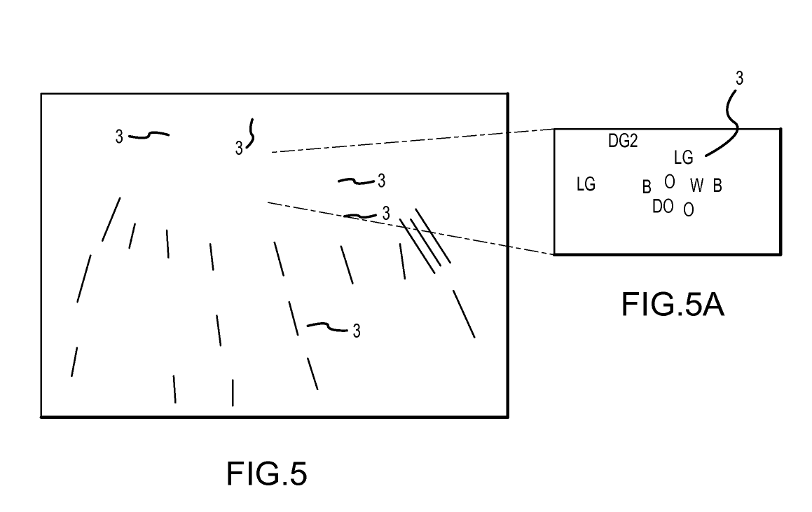

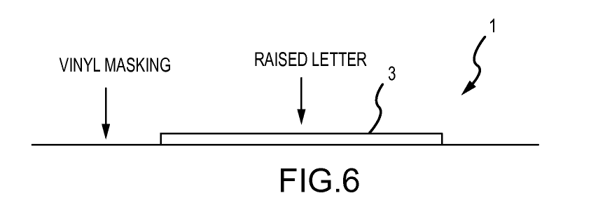

Turning now to the drawings where the purpose is to describe preferred embodiments of the invention and not to limit same, FIGS. 4-6 show a stencil panel in accordance with aspects of the invention. Stencil panel 1 has a plurality of forms 2, wherein one or more forms 2 has a specific size and shape, and is used to create an opening in stencil panel 1 for a particular color of paint to be applied to a surface to which stencil panel 1 is applied. Some of the forms specifically identified in FIG. 4 are circular (2A), arrow-head shaped (2B), and multi-shaped (2C). The invention, however, is not limited to any particular number, type or shape of forms 2.

Each form 2 has one or more indicia 3 that is either raised (as shown in FIGS. 4-6), depressed, and/or treated with a coating, such as a luminescent coating that glows under ultraviolet light, so when the indicia 3 is covered with paint it can still be recognized, either because the indicia 3 is raised or depressed and is still visible (as best seen in FIGS. 4 and 4A) and/or because the indicia can be seen when the stencil panel is exposed to a certain type of light. The indicia may be letters, numbers, shapes, textures or anything that can be used to identify one type of form from another because each type of form generally receives a different color of paint. The indicia may be raised or depressed by up to ⅛″, or up to ¼″ or more. Further, the indicia may have a surface area of ¼ square inches or more, ½ square inches or more, 1 square inch or more, or greater than 1 square inch.

In a preferred use of a stencil panel 1 according to the invention, the stencil panel 1 is applied to a surface to be painted and the one or more forms 2 for a particular color are removed from the stencil panel 1. The first color is then applied. Afterwards, the one or more forms 2 for a second color, which can be identified through the first layer of paint, are removed and the second color is applied. This process is repeated until all of the colors of paint are applied to a surface using the proper one or more forms 2 for each color. Additionally, before applying subsequent layers of paint, the surface which already has paint applied to it may be remasked in any suitable manner such as by using masking tape, additional paint masking, or liquid paint mask. This prevents one color of paint from covering or partially covering a surface that has already been painted a different color. After the completion of painting the surface, the stencil panel 1 is removed.

Having thus described some embodiments of the invention, other variations and embodiments that do not depart from the spirit of the invention will become apparent to those skilled in the art. The scope of the present invention is thus not limited to any particular embodiment, but is instead set forth in the appended claims and the legal equivalents thereof. Unless expressly stated in the written description or claims, the steps of any method recited in the claims may be performed in any order capable of yielding the desired result.

1. A stencil panel for applying paint to a surface, the panel having one or more forms that can be removed to create openings through which the surface is exposed, and indicia on or adjacent to each form that is visible when covered with paint.

2. The stencil panel of claim 1 wherein the indicia is raised.

3. The stencil panel of claim 2 wherein the indicia is raised at least ⅛″.

4. The stencil panel of claim 2 wherein the indicia has a surface area of at least ¼ square inch.

5. The stencil panel of claim 4 wherein the indicia has a surface area of at least one square inch.

6. The stencil panel of claim 1 wherein the indicia includes a luminescent substance.

7. The stencil panel of claim 1 wherein the indicia is a depression.

8. The stencil panel of claim 7 wherein the indicia is depressed by at least ⅛″.

9. The stencil panel of claim 1 wherein the indicia is one or more of a number, a letter, a shape and a texture.

10. A method of applying a multi color paint pattern on a surface, the method comprising:
(a) applying one or more stencil panels according to claim 1 on the surface;
(b) removing one or more first forms from the one or more stencil patterns to expose a first portion of the surface and painting the first portion of the surface a first color;
(c) removing one or more second forms from the one or more stencil panels to expose a second portion of the surface, and painting the second portion of the surface a second color.

11. The method according to claim 10 wherein the indicia is raised.

12. The method according to claim 11 wherein the indicia is raised at least ¼″.

13. The method according to claim 11 wherein the indicia has a surface area of at least one square inch.

14. The method according to claim 11 wherein the indicia has a surface area of at least two square inches.

15. The stencil panel of claim 10 wherein the indicia is a depression.

16. The stencil panel of claim 10 wherein the indicia is one or more of a number, a letter, a shape and a texture.

17. The stencil panel of claim 16 wherein the indicia is depressed by at least ⅛″.

18. The method of claim 10 that further includes painting a second subset of the plurality of stencil panels a third color.

19. The method of claim 10 that further includes the step of removing one or more third forms from the one or more stencil panels to expose a third portion of the surface, and painting the third portion of the surface a third color.

20. The method of claim 10 that further includes the step of placing a mask over the first portion of the surface before painting the second portion of the surface.

21. The method of claim 19 that further includes the step of placing a mask over the first portion of the surface and the second portion of the surface before painting the third portion of the surface.
